(19) United States
(12) Patent Application Publication
(10) Pub. No.: US 2001/0023276 A1
(43) Pub. Date: Sep. 20, 2001

(54) Polymeric material, method for its manufacture, and its utilization

(76) Inventor: Uwe Schoenfeld, Haigerloch (DE)

Correspondence Address: MARSHALL & MELHORN, FOUR SEAGATE, EIGHT FLOOR, TOLEDO, OH, 43604, US

(21) Appl. No.: 09/746,256

(22) Filed: Dec. 21, 2000

Related U.S. Application Data
(63) Continuation-in-part of application No. 08/981,564, filed on Mar. 31, 1998, now abandoned.
Application No. 08/981,564 is a 371 of international application No. PCT/DE96/01243, filed on Jul. 5, 1996.

(30) Foreign Application Priority Data
Jul. 5, 1995 (DE) DE 19524514.8

(51) Int. Cl. C08F 8/00

(52) U.S. Cl. 525/107

(57) ABSTRACT

The invention relates to a polymeric material on the basis of renewable raw materials, containing a reaction product from 10-90% by mass of a triglyceride with at least 2 epoxy and/or aziridine groups and 5-90% by mass of a polycarboxylic acid anhydride with 0.01-20% by mass of a polycarboxylic acid.

### CROSS REFERENCE TO RELATED APPLICATIONS

This application is a continuation-in-part (CIP) application claiming priority from U.S. application Ser. No. 08/981,564, filed on Mar. 31, 1998, which is the U.S. National Phase of International Application No. PCT/DE96/01243, filed on Jul. 5, 1996. U.S. application Ser. No. 08/981,564 is pending as of the filing date of this application. U.S. application Ser. No. 08/981,564 is hereby incorporated by reference as if set forth in its entirety herein.

### SUMMARY OF THE INVENTION

The invention relates to a polymeric material on the basis of renewable raw materials, to a method of manufacturing this material, and to its utilization.

Organic plastics, which are today used on a large scale in industry, are obtained almost exclusively on a petrochemical basis. For example, in the furniture and building industries, wood materials are used, which are bonded with UF (urea formaldehyde), MUF (Methylurethane Formaldehyde), PF (Phenol-Formaldehyde Resin) or more rarely PUR (Polyurethane). Cladding panels, end pieces, cable ducts, etc. mostly consist of polyvinyl chloride (PVC). In the area of windows, plastics windows are also used today in large numbers with frames made of PVC. PVC is also a material for windows with frames of PVC. PVC as a material for such components however has serious disadvantages. On the one hand the recycling problem has not yet been satisfactorily solved, and on the other hand PVC develops dangerous gases when burning. Covering members for machines and apparatus, high-quality pressed moldings, frequently consist of PF, MF (Methyl-Formaldehyde Resin), EP (Ethylene/Propylene Polymer) or UP (Unsaturated Polymers)—reinforced fibre materials or mats, which are for example used in the automobile industry. In the course of the growing CO₂ discussion and a possible global climatic change entailed therewith, there is today an urgent requirement for novel, extensively CO₂-neutral plastics which satisfy the requirements set for plastics on a petrochemical basis used at present, and which could partly replace these. More appropriately such polymeric materials are obtained from educts on the basis of renewable materials.

There have already become known in prior art binders or binder combinations which also partly contain renewable raw materials. These developments refer in particular to the field of polyurethane. Thus, it is known fro U.S. Pat. No. 4,582,891 to convert castor oil, i.e., a renewable material, with polyisocyanate and an inorganic filler.

From EP 01 51 585 there is known a two-component polyurethane adhesive system, in which there are used as an oleochemical polyol ring-scission products of epoxidized fatty alcohols, fatty acid esters (particularly triglycerides) or fatty acid amides with alcohol. It is further known to use epoxidized triglycerides as softeners. Such a method is described for example in PCT/EP94/02284.

From U.S. Pat. No. 3,578,633 there is known a method of hardening polyepoxides with polycarboxylic acid anhydride, using special alkali salts of selected carboxylic acids. According to this, polyepoxides with more than one vicinal epoxy group per molecule are used exclusively. The polymers obtained according to this document however have the drawback that on the one hand they originate from physiologically harmful initial substances (e.g., lithium salts), and on the other hand that the polymers obtained do not have the necessary strength. This is clearly ascribed to the fact that according to the U.S. patent a basic reaction takes place which reinforces the cross-linking of external epoxy groups which, however, are in no way present in epoxidized triglycerides.

Polymeric products are known from DE 4,135,664 which are produced from epoxidized triglycerides and part esters of polycarboxylic acids with at least two free carboxylic acid groups and with water-repellent agents. According to DE 4,135,664 however, resilient coating compounds are obtained with increased water resistance, which likewise do not have any satisfactory properties with respect to strength and the range of variation of polymeric system.

Proceeding from this point it is therefore the object of the present invention to indicate a novel material which is constructed on the bass of renewable raw materials, and which leads to polymeric materials which allow a wide range of applications due to their strength.

The object is achieved as regards the polymeric material by the characterizing features of claim 1, and as regards the method by the characterizing features of claims 15 and 16. The sub-claims illustrate advantageous further developments.

Thus there is proposed according to the invention a polymeric material which substantially contains a reaction product from three components, i.e., 10-90% by mass of a triglyceride, 5-90% by mass of a polycarboxylic acid anhydride with 0.01-20° C. by mass of a polycarboxylic acid. The applicant has been able to demonstrate that, surprisingly, polymeric materials, which contain a reaction product in the prescribed way, have surprising properties with regard to the strength and the range of variation of the properties of the material.

A decisive factor in the material according to the application is that polycarboxylic acid anhydrides are used which function as cross-linkers, so that the cross-linking density of the polymer obtained is decisively increased. As a result of this, hard polymers are obtained.

The main ingredients of the reaction product are thus epoxidized triglycerides and polycarboxylic acid anhydrides, which are cross-linked with one another. The cross-linking reaction is started by the addition of small quantities of polycarboxylic acid (0.01 to 20% by mass). The polycarboxylic acid thus clearly has the advantageous function of an initiator for the internally-present epoxy groups of the triglycerides.

Accordingly, by means of the use of polycarboxylic acid anhydrides, the adjacent OH groups originating from epoxy ring scission are cross-linked in the form of an additional reaction. The free carboxylic acid group resulting on the polycarboxylic acid anhydride thus clearly in turn opens another epoxy ring, an adjacent OH group likewise being obtained which reacts with an additional carboxylic acid anhydride group, with further addition. The reaction is then started when an epoxy ring has been opened and the adjacent OH group has originated. This initiation of the cross-linking is effected by the addition of small quantities of polycarboxylic acid. Thus, it is essential that an opening of the epoxy group is present as a reaction starter. A possible reaction procedure is shown diagrammatically in the following.

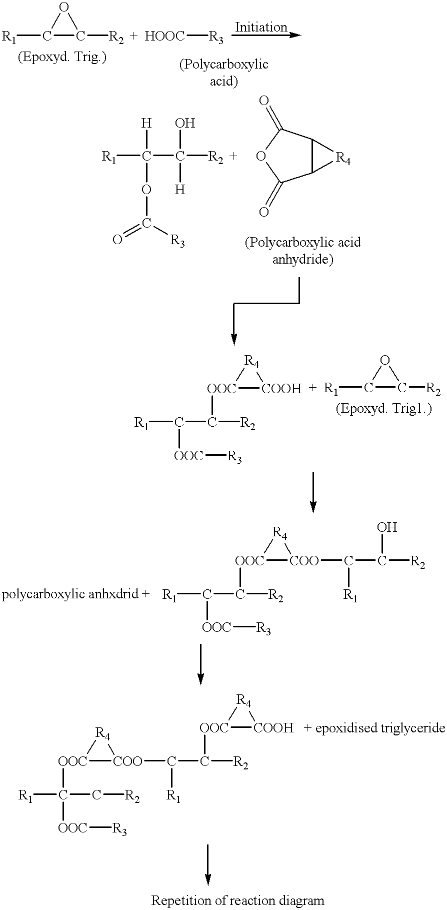

In contrast to prior art with the cross-linking in pure polycarboxylic acids, the hydroxy groups formed react under polyaddition with the polycarboxylic acid anhydride. It was also possible to prove this by DSC and IR tests.

Thus, an essential feature in the polymeric material according to the invention is that it contains a reaction product comprising 10-90% by mass of a triglyceride and 5-90% by mass of a carboxylic acid anhydride, the reaction being initiated by small amounts of carboxylic acid (0.01-20% by mass). It is preferred in this respect if the reaction product contains 35-70% by mass of a triglyceride and 10-60% by mass of a polycarboxylic acid anhydride, and 0.05-10% by mass of the polycarboxylic acid.

Examples of epoxidized triglycerides which can be used to produce the reaction product according to the invention are soya oil, linseed oil, perilla oil, tung oil, oiticica oil, safflower oil, poppy oil, hemp oil, cottonseed oil, sunflower oil, rape oil, triglycerides from euphorbia plants such for example as euphorbia-iagascae oil, and highly-oleic triglycerides such for example as highly-oleic sunflower oil or euphorbia iathyris oil, groundnut oil, olive oil, olive seed oil, almond oil, kapok oil, hazelnut oil, apricot seed oil, beechnut oil, lupin oil, maize oil, sesame oil, grape seed oil, lallemantia oil, castor oil, oils of sea creatures such as herring oil and sardine oil or menhaden oil, whale oil and triglycerides with a high proportion of saturated fatty acids which are subsequently converted to an unsaturated condition by dehydration, or mixtures thereof. Due to the reaction with the hydroxy groups it is possible, in addition to epoxidized triglycerides, also partly to use hydroxylized triglycerides as further ingredients. Such hydroxylized triglycerides are for example hydroxylized highly-oleic or castor oil. In this way the physical properties of the polymers can be altered to a large extent. An essential feature however, is that epoxidized triglycerides are always present, as otherwise chain termination will occur. It is also possible to use triglycerides with azardine groups or triglycerides with mixtures of epoxy groups and aziridine groups. Various synthesizing methods are known for producing aziridines. One method of production is cycloaddition, e.g., of carbenes to azomethines (Breitmaier E., G. Jung, Org. Chemie vol. 1, E. Thieme Verlag, Stuttgart), or of nitrenes to olefines. A synthesis by reduction of α-chloronitriles or oximes with LiAlH₄ is likewise possible (Bull, Chem. Soc. Jpn. 40, 432 (1967) and Tetrahedro 24, 3681 (1968).

With polycarboxylic acid anhydrides, those which have a cyclic basic framework, i.e., polycarboxylic acid anhydrides produced from cyclic polycarboxylic acids with at least two free carboxylic acid groups, are preferred. Examples of this are cyclohexane dicarboxylic acid anhydride, cyclohexene dicarboxylic acid anhydride, phthalic acid anhydride, trimellitic acid anhydride, hemimellitic acid anhydride, pyromellitic acid anhydride, 2,3-naphthalic acid anhydride, 1,2 cyclopentane dicarboxylic acid anhydride, 1,2 cyclobutane dicarboxylic acid anhydride, quinolinic acid anhydride, norbornene dicarboxylic acid anhydride (NADICAN), and the methyl-substituted compounds MNA, pinic acid anhydride, norpinic acid anhydride, truxillic acid anhydride, perylene 1,2-dicarboxylic acid anhydride, caronic acid anhydride, narcamphane dicarboxylic acid anhydride, isatoic acid, anhydride, camphoric acid anhydride, 1,8-naphthalic acid anhydride, diphenic acid anhydride, o-carboxyphenylbenzoic acid anhydride, 1,4,5,8-naphthalic intera carboxylic acid anhydride or mixtures thereof.

Also useable are polycarboxylic acid anhydrides from open-chained di- and polycarboxylic acids with at least two free carboxylic acid groups, such for example as aconitic acid anhydride, citraconic acid anhydride, glutaric acid anhydride, itaconic acid anhydride, tartaric acid anhydride, diglycolic acid anhydride, ethylenediamineinterabenzoic acid anhydride or mixtures thereof.

In the case of the initiators used according to the invention, i.e., in the case of the polycarboxylic acids, the di- and tri-carboxylic acids are preferred. Examples of this are citric acid derivates, polymerized tall oils, azelaic acid, gallic acid, di- or polymerized oleoresin acids, di- or polymerized anacardic acid, also cashew nut shell liquid, polyuronic acids, polyalginic acids, mellitic acids, trimesic acids, aromatic di- and polycarboxylic acids such for example as phthalic acid, trimellitic acid, hemimellitic acid, pyromellitic acid and their aromatically substituted derivates such for example as hydroxy or alkyl phthalic acid, unsaturated cyclic di- and polycarboxylic acids such for example as norpinic acid, heterocyclic di- and polycarboxylic acids such for example as loiponic acid or cincholoiponic acid, bi-cyclic di- and polycarboxylic acids such for example as norbornene dicarboxylic acids, open-chained di- and polycarboxylic acids such for example as malonic acid and its longer-chained homologues and its substituted compounds such for example as hydroxy- and keto- di- and polycarboxylic acids, pectinic acids, humic acids, polymeric cashew nut shell liquid with at least two free carboxylic acid groups in the molecule, or mixtures thereof.

A further preferred embodiment of the invention proposes that the polymeric material contains a reaction product produced from the initial ingredients described above, yet with an added catalyst. In this case the catalyst can be added in a quantitative ratio of 0.01-10% by mass, preferably of 0.05-5% by mass. There could basically serve as a catalyst all compounds serving to accelerate cross-linkings of epoxy resins. Examples of this are tertiary amines such as N, N′benzyldimenthyl aniline, imidazol and its derivates, alcohols, phenols and their substituted compounds, hydroxycarboxylic acids such as lactic acid or solicylic acid, organometallic compounds such as triethanolamine titanate, di-n-butyl tin laurate, Lewis acids, particularly boron trifluoride, aluminium trichloride and its aminic complex compounds, Lewis bases, particularly alcoholates, multifunctional mercapto compounds and thio acids and organophosphorus compounds, particularly triphenylphosphite, and bis-β-chloroethylphosphite, bi-cyclic amines such as [2,2,2,]diazabicyclooctane, chinuclidine or diazabicycloundecene, alkali and alkaline earth hydroxides, Grignard compounds or mixtures thereof.

It should be particularly emphasized that the polymeric material according to the invention can consist exclusively of the reaction product as described above or, depending on the scale of requirements, can also additionally contain a filler or flame-retardant means. When the polymeric material contains only a reaction product and a filler, it is preferred that it should contain 2-98% by mass of the reaction product and 98-2% by mass of the filler. It is particular preferred if the polymeric material contains 6-90% by mass of the reaction product and 10-94% by mass of the filler.

Particularly preferred examples of fillers are organic fillers on the basis of cellulose-containing materials such as wood flour, sawdust or timber waste, rice husks, straw and flax fibres on the basis of proteins, particularly sheep wool and inorganic fillers on the basis of silicates and carbonates such as sand, quartz, corundum, silicon carbide and glass fibres, or mixtures thereof. The polymeric material according to the invention can also contain up to 50% by mass of a flame-retardant agent. Preferred flame retardants are: aluminium hydroxide, halogen, antimony, bismuth, boron or phosphorus compounds, silicate compounds or mixtures thereof.

In producing the material according to the preferred embodiment with the filler, the procedure can be such that on the one hand firstly a mixture of the initial ingredients, i.e., the triglyceride of the polycarboxylic acid anhydride and of the carboxylic acid is produced, and then that this mixture is pre-polymerized to a viscosity of 0.2-20,000 CPS at 20° C.-200° C., the filler then being added. In connection therewith if necessary, also after shaping, if necessary under pressure, hardening can be effected. It is however also possible to mix all the additive materials and then carry out pre-polymerization.

On the other hand, the procedure can be such that all the ingredients, i.e., the triglycerides, the polycarboxylic acid anhydrides and the carboxylic acids as well if necessary as the further additive materials, such as filler and flame-retardants, are mixed, and that hardening is then subsequently carried out at an increased temperature, and increased temperature and increased pressure.

It is also noted that in at least one embodiment of the present invention, the polycarboxylic acid anhydride and the triglyceride are essentially non-reactive with each other outside of the presence of an initiator.

Hardening can be carried out in ranges from >20° C. to 200° C. at a pressure of 1 bar to 100 bar. Duration of hardening depends on the temperature, the pressure and if necessary the added catalyst. Hardening time can lie in a range from 10 seconds to 24 hours. A temperature range of 50-150° C. is preferred.

The polymeric material according to the invention can also be infiltrated into fleeces or mats. In this way fibre-reinforced materials can be produced.

With the method according to the invention the mixture obtained can be placed individually into molds and pressed, or endless production can be carried out. Endless production can also be carried out by extrusion or hot-rolling.

After hardening the reaction mixture forms an enclosed and extremely smooth surface; the plastic definition, i.e., the size of geometric shapes, is extremely large. The finest filigreed patterns can be extremely precisely reproduced by the material.

The material according to the invention is particularly characterized by the fact that it is toxologically harmless, and thus does not have the disadvantages of PVC and/or other comparable materials such, for example, as those on a polyurethane base. It should be mentioned that the novel material can have similar mechanical properties to PVC, EP or PES. These variant materials are rigidly elastic and of high strength. Highly-filled cellulose-containing polymeric materials according to the invention, obtained by pressing or extrusion, have high mechanical strengths. In the case of mechanical spot-loading such for example as occurs when fastening wood screws or driving in wood nails, the structure of the surrounding material is retained. Splintering such as is observed for example with wood, is not observed. The material can be mechanically processed without problems. When sawn or milled, no splintering of the lateral surfaces, or even breakage of smaller particles, is observed.

By means of added proportions of hydroxylized triglycerides, moldings can be obtained which at ambient temperature have a partly-plastic behavior and at the same time excellent tear strength. Depending on the degree of cross-linking, which is in theory influenced by the composition of the initial ingredients, moldings can be obtained which permit heat-shaping of the polymeric material members. In particular, when aluminium hydroxide is incorporated, an appreciable improvement in fire resistance is noted during flame tests. The incorporation of aluminium hydroxide and the emission of water entailed prevent the direct attack of flames. Thus fire resistance class BS according to DIN 4102 is fulfilled.

In numerous tests it has also become apparent that the material according to the invention has a notable water-absorbency; for this purpose cellulose-containing highly-filled blanks were submerged in water for a lengthy period. After 80 hours no appreciable quantity of water had been absorbed by the material. No physical or chemical changes could be observed in the material.

The invention will be explained in more detail by the following examples:

### EXAMPLE 1

53.5% by mass of epoxidized linseed oil with an acid content of 9% by mass are mixed with 42.8% by mass of camphoric acid anhydride and 2.7% by mass of a mixture of di- and trimeric abietic acid. This mixture is homogenized with 1% by mass of a 50% ethanolic chinuclidine solution. 10% by mass of this mixture is mixed with 90% by mass of straw and pressed for 10 minutes at a pressure of 15 bar and at a temperature of 180° C. The fibreboard obtained has a physical density of 0.62 [g/cm³], is characterized by high-quality mechanical properties and has outstanding water resistance. It can be used in the building and furniture industries as a fibreboard material.

### EXAMPLE 2

80% by mass of epoxidized perilla oil with an acid content of 8% by mass are mixed with 16 parts by mass of pyromellitic acid anhydride and 4% by mass of a trimerized fatty acid. 30% by mass of this mixture is applied to 70% by mass of a jute-hemp fibre fleece in such a way that the fibre fleece is homogeneously wetted. The infiltrated fibre mat is then pressed at a pressure of 10 bar and a temperature of 170° C. for 10 minutes. The fibre product obtained has high elasticity, resistance to breakage and water-resistance. It may be used in many areas in which plastic-reinforced fibres or fibre-reinforces plastics are used, such for example as fibre-reinforced shell or mold members of covering members.

### EXAMPLE 3

42.9% by mass of epoxidized soya oil with an acid content of 6.5% by mass are mixed with 21.5% by mass of a hydroxylized highly-oleic oil. To this mixture there is added 34.3% by mass of a norbornene dicarboxylic acid anhydride and 1.3% by mass of a 50% methanolic DABCO solution (adipic acid). DABCO in this application refers to a product line by Air Products, and the particular product discussed herein contains adipic acid. The mixture is homogenized and then cross-linked at a temperature of 140° C. within 15 minutes. The product obtained is transparent, plastically deformable and has a high tear strength. This product can be suitable for coating materials and components which must be plastically deformable, such for example as electrical cables.

### EXAMPLE 4

72.7% by mass of epoxidized hemp oil with an acid content of 10.5% by mass are mixed with 27.3% by mass of trimellitic acid anhydride. 8% by mass of this mixture are mixed with 92% by mass of dried grain husks (which contain sebacic acid) and pressed at a pressure of 15 bar and a temperature of 170° C. for 8 minutes. The fibreboard obtained has a physical density of 0.88 [g/cm³], is characterized by high water-resistance and excellent mechanical strength, and can be used as a fibreboard in the building and furniture industries.

### EXAMPLE 5

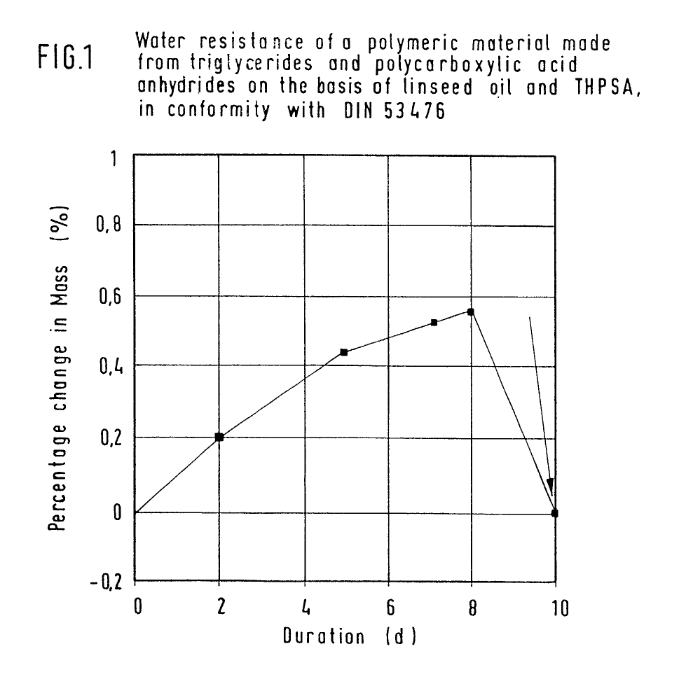

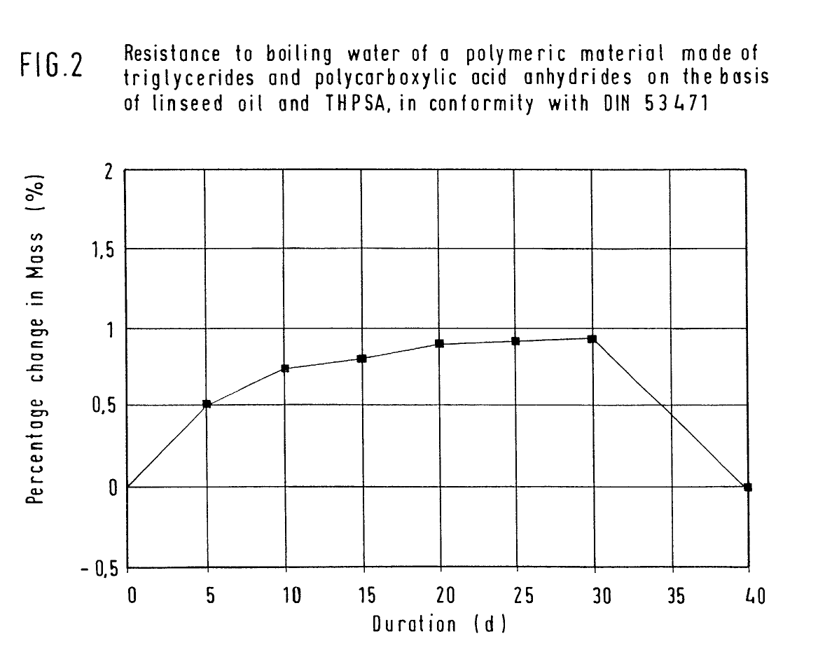

54.7% by mass of epoxidized linseed oil with an acid content of 9.6% by mass are mixed with 43.7% by mass of tetrahydrophthalic acid anhydride and 1.1% by mass of adipic acid. This mixture is homogenized with 0.5% by mass of DBN and cross-linked at 145° C. within 5 minuts to form a hard, transparent molding. The material obtained is resistant to water and boiling water (see FIGS. 1 and 2) and has high mechanical strengths. The material can be heated up to 300° C. without decomposition. It can be suitable for example as a covering member for apparatus and machinery of the most varied types.

### EXAMPLE 6

60% by mass of epoxidized soya oil with an acid content of 6.5% by mass are mixed with 36% by mass of 1,2 cyclohexane dicarboxylic acid anhydride and 1.1% by mass of dimerized pine resin with an acid number of 154. The mixture is homogenized with a 50% butanolic imidazol solution and cross-linked within 10 minutes at 140° C. The polymeric material obtained is transparent, is characterized by high water resistance and can be hot-shaped at a temperatue of approx. 90° C. Below this temperature it has high mechanical strengths.

### EXAMPLE 7

69.9% by mass of a highly-oleic oil from euphorbia lathyris with a nitrogen content of 4.3% by mass are mixed with 28% by mass phthalic acid anhydride, 1.5% by mass of sebacid acid and 0.6% by mass of an isopropanolic chinuclidine solution. The mixture is cross-linked at 145° C. in a period of 5 minutes to form a hard elastic, transparent polymeric material which has a high water resistance and wear resistance.

### EXAMPLE 8

51.5% by mass of epoxidized tung oil with an acid content of 10.5% by mass are mixed with 45.5% by mass of camphoric acid anhydride and 2.5% by mass of a 70% ethanolic citric acid solution. 0.5% by mass of DABCO are added to this mixture, and the mixture is homogenized. 30% by mass of this mixture is applied to 70% by mass of a dry coco fibre fleece, so that the fibres are homogeneously infiltrated by the reactive mixture. The infiltrated coco fibre is then preheated at 130° C., for 20 minutes. The reactive mixture in this case reacts to form a prepolymer with a viscosity of approx. 10,000 [mPas]. The pre-treated fleece is then placed in a mold and pressed at 15 bar for 1 minute at a temperature of 160° C. The fibre product obtained has high mechanical strength, is extremely water resistant and temperature resistant. It can be used in areas in which plastics-reinforced fibre fleece materials or fibre-reinforced plastics are used.

### EXAMPLE 9

A mixture of 61.6% by mass of epoxidized linseed oil with an acid content of 9.6% by mass, and 15.4% by mass of epoxidized sardine oil with an acid content of 10.5% by mass are mixed with 19.2 parts by mass of pyromellitic acid dianhydride and 3.8% by mass of trimerized fatty acid. 25% by mass of this mixture are homogenized with 75% by mass of wood flour with an average fibre length of 300 μm. The wetted powder is then processed with the aid of a RAM extruder at 160° C. and a pressure of 40 bar, forming endless moldings. The products obtained have high mechanical stability and characterized by outstanding water resistance.

### EXAMPLE 10

53.2% by mass of epoxidized safflower oil with an acid content of 9% by mass are mixed with 10% by mass of aconitic acid anhydride, 32.5% by mass of methyl norbornene dicarboxylic acid anhydride and 2.6% by mass of dimerized anacardic acid. To this mixture there are added 1.7% by mass of a propanolic DABCO solution, and the mixture is then homogenized. 10% by mass of this mixture are mixed with 90% by mass of dried and ground rice husks with an average grain size of 0.5 mm, until a homogeneously wetted powder is obtained. This mixture is then pressed at a temperature of 130° C. for 15 minutes at a pressure of 15 bar. The material obtained has a physical density of 0.9 [g/m] and can be processed by chip-removal. This material is suitable in all cases where middle-density fibreboards (MDF) are used.

### EXAMPLE 11

50.5% by mass of epoxidized linseed oil are mixed with 2.5% by mass of trimerized abietic acid. This mixture is homogenized with 1.8% by mass of a 50% isobutanolic chinuclidine solution. 30% by mass of this mixture is homogenized with 35% by mass of barytes, 5% by mass of a pigment such for example as rutile and 30% by mass of a conglomerate of muscovite, chlorite and quartz powders. The mixture is then cross-linked in a mold at a pressure of 30 bar and a temperature of 140° C. within 8 minutes to form hard elastic duroplastic moldings which have a high resistance to water and boiling water, and high mechanical strengths. The material can for example be used as a cover member for apparatus and machinery of the most varied types.

In at least one embodiment of the present invention, a polymeric material on the basis of renewable raw materials comprises a reaction product produced by cross-linking from 10-90% by mass of a triglyceride having an epoxy or aziridine functional group, or a mixture of said triglycerides, and 5-90% by mass of a polycarboxylic acid anhydride, manufactured from cyclic polycarboxylic acids with at least two free carboxylic acid groups. The polycarboxylic acid anhydride and the triglyceride are essentially non-reactive with each other outside the presence of an initiator. The polycarboxylic acid anhydride and the triglyceride are mixed, with an initiator, consisting essentially of 0.01-20% by mass of a polycarboxylic acid.

In a preferred embodiment of the present invention, the total of the triglyceride, or mixture of triglycerides, and the polycarboxylic acid anhydride in the reaction product is greater than 50% by mass.

In an additional embodiment of the present invention, a cross linked polymeric material based on renewable raw materials comprises a reaction product produced by the reaction of a mixture consisting essentially of 10-90% by mass of a triglyceride having epoxy or aziridine groups or a mixture of said triglycerides, 5-90% by mass of a polycarboxylic acid anhydride manufactured from cyclic polycarboxylic acids with at least two free carboxylic acid groups, and 0.01-20% by mass of a polycarboxylic acid.

As discussed herein, DABCO is a product comprising adipic acid. Additionally, dried grain husks, as used herein, are a form of sebacic acid.

One feature of the present invention teaches a polymeric material on the basis of renewable raw materials, comprising a reaction product produced by cross-linking from 10-90% by mass of a triglyceride having an epoxy or aziridine functional group, or a mixture of said triglycerides, and 5-90% by mass of a polycarboxylic acid anhydride, manufactured from cyclic polycarboxylic acids with at least two free carboxylic acid groups, with an initiator consisting essentially of 0.01-20% by mass of a polycarboxylic acid.

Another feature of the present invention is that in at least one embodiment of the present invention, the epoxidized triglycerides are selected from the group consisting of soya oil, linseed oil, perilla oil, tung oil, oiticica oil, safflower oil, poppy oil, hemp oil, cottonseed oil, sunflower oil, rape oil, triglycerides from euphorbia plants such for example as euphorbia-iagascae oil, and highly-oleic triglycerides such for example as highly-oleic sunflower oil or euphorbia iathyris oil, groundnut oil, olive oil, olive seed oil, almond oil, kapok oil, hazelnut oil, apricot seed oil, beechnut oil, lupin oil, maize oil, sesame oil, grapeseed oil, lallemantia oil, castor oil, oils of sea creatures such as herring oil and sardine oil or menhaden oil, whale oil and triglycerides with a high proportion of saturated fatty acids which are subsequently converted to an unsaturated condition by dehydration, and mixtures thereof.

Another feature of the present invention is that in at least one embodiment of the present invention, the epoxidized triglycerides additionally contain hydroxylized triglycerides such as castor oil.

Another feature of the present invention is that in at least one embodiment of the present invention, the polycarboxylic acid anhydrides are selected from the group consisting of cyclohexane dicarboxylic acid anhydride, cyclohexene dicarboxylic acid anhydride, phthalic acid anhydride, trimellitic acid anhydride, hemimellitic acid anhydride, pyromellitic acid anhydride, 2,3-napthalic acid anhydride, 1,2 cyclopentane dicarboxylic acid anhydride, 1,2 cyclobutane dicarboxylic acid anhydride, quinolinic acid anhydride, norbornene dicarboxylic acid anhydride (NADICAN), and the methyl-substituted compounds MNA, pinic acid anhydride, norpinic acid anhydride, truxillic acid anhydride, perylene 1,2-dicarboxylic acid anhydride, caronic acid anhydride, narcamphane dicarboxylic acid anhydride, isatoic acid anhydride, camphoric acid anhydride, 1,8-naphthalic acid anhydride, diphenic acid anhydride, o-carboxyphenylbenzoic acid anhydride, 1,4,5,8-naphthalic intera carboxylic acid anhydride, and mixtures thereof.

In at least one embodiment of the preseent invention, a di- or tricarboxylic acid is used as a polycarboxylic acid.

In at least one embodiment of the present invention, the polycarboxylic acid is selected from the group consisting of citric acid derivates, polymerized tall oils, azelaic acid, gallic acid, di- or polymerized oleoresin acids, di- or polymerized anacardic acid, cashew nut shell liquid, polyuronic acids, polyalginic acids, mellitic acids, trimesic acids, aromatic polycarboxylic acids such for example as phthalic acid, trimellitic acid, hemimellitic acid, pyromellitic acid and their aromatically substituted derivates such for example as hydroxy or alkyl phthalic acid, unsaturated cyclic polycarboxylic acids such for example as norpinic acid, heterocyclic polycarboxylic acids such for example as loiponic acid or cincholoiponic acid, bi-cyclic polycarboxylic acids such for example as norbornene dicarboxylic acids, open-chained polycarboxylic acids such for example as malonic acid and its longer-chained homologues and its substituted compounds such for example as hydroxy- and keto- di- and polycarboxylic acids, pectinic acids, humic acids, polymeric cashew nut shell liquid with at least two free carboxylic acid groups in the molecule, and mixtures thereof.

In at least one embodiment of the present invention, the polymeric material contains 2-98% by mass of a reaction product according and 98-2% by mass of a filler.

In at least one embodiment of the present invention, the filler is selected from the group consisting of organic fillers on the basis of cellulose-containing materials such as wood flour, sawdust or timer waste, rice husks, straw and flax fibers on the basis of proteins, particularly sheep wool and inorganic fillers on the basis of silicates and carbonates such as sand, quartz, corundum, silicon carbide and glass fibers, and mixtures thereof.

In at least one embodiment of the present invention, during production of the reaction product, 0.01-10% by mass of catalyst are added.

In at least one embodiment of the present invention, the catalyst is selected from the group consisting of tertiary amines such as N, N′benzyldimenthyl aniline, imidazol and its derivates, alcohols, hydroxycarboxylic acids such as lactic acid or salicylic acid, and thio acids and organophosphorus compounds, particularly triphenylphosphite, trisnonylphenylphosphite, and bis-β-chloroethylphosphite, bi-cyclic amines such as 2,2,2, diazabicyclooctane, chinuclidine or diazabicycloundecenes, and mixtures thereof.

In at least one embodiment of the present invention, the polymeric material includes a flame-retardant selected from the group consisting of aluminium hydroxide, halogen, antimony, bismuth, boron or phosphorus compounds, silicate compounds, and mixtures thereof.

Another feature of the present invention is a method of producing a polymeric material comprising mixing a triglyceride having an epoxy or aziridine functional group, a polycarboxylic acid anhydride, a polycarboxylic acid and optionally further additives such as fillers and/or catalyst and/or flame retardants; and hardening the mixture.

In at least one embodiment of the present invention, the triglyceride, the polycarboxylic acid anhydride, the polycarboxylic acid and if necessary the catalyst are previously cross-linked to a viscosity of 0.2-20,000 CPS at 20° C.-200° C., in that then the filler and/or the flame retardant are added, and in that hardening is then carried out.

In at least one embodiment of the present invention, the hardening is carried out at a temperature in the range of >20° C. to 200° C. and at a pressure of 1 bar to 100 bar for a period in the range of 10 seconds to 24 hours.

In at least one embodiment of the present invention, the aromatic polycarboxylic acids are selected from the group consisting of phthalic acid, trimellitic acid, hemimellitic acid, and pyromellitic acid.

In at least one embodiment of the present invention, the aromatically substituted derivatives of the aromatic polycarboxylic acids are selected from the group consisting of hydroxy-phthalic acid and alkyl-phthalic acid.

In at least one embodiment of the present invention, the unsaturated cyclic polycarboxylic acids are norpinic acid.

In at least one embodiment of the present invention, the heterocyclic polycarboxylic acids are selected from the group consisting of loiponic acid and cincholoiponic acid.

In at least one embodiment of the present invention, the bi-cyclic polycarboxylic acids are norbornene dicarboxylic acids, the open-chained polycarboxylic acids is malonic acid, and the longer-chained homologues and the substituted compounds of the open-chained polycarboxylic acids are selected from the group consisting of hydroxy-polycarboxylic acids, keto-polycarboxylic acids, and di-carboxylic acids.

In at least one embodiment of the present invention, the reaction product is produced by cross-linking 35% or more by mass of said triglyceride or mixture of said triglycerides.

In at least one embodiment of the present invention, the total of the triglyceride, or mixture of triglycerides, and said polycarboxylic acid anhydride in the reaction product is greater than 50% by mass.

Another feature of the present invention is a cross linked polymeric material based on renewable raw materials, comprising a reaction product produced by the reaction of a mixture consisting essentially of 10-90% by mass of a triglyceride having epoxy or aziridine groups or a mixture of said triglycerides, 5-90% by mass of a polycarboxylic acid anhydride manufactured from cyclic polycarboxylic acids with at least two free carboxylic acid groups, and 0.01-20% by mass of a polycarboxylic acid.

At least one embodiment of the present invention is a polymeric material on the basis of renewable raw materials, comprising a reaction product produced by cross-linking from 10-90% by mass of a triglyceride having an epoxy or aziridine functional group, or a mixture of said triglycerides, and 5-90% by mass of a polycarboxylic acid anhydride, manufactured from cyclic polycarboxylic acids with at least two free carboxylic acid groups, the polycarboxylic acid anhydride and the triglyceride being essentially non-reactive with each other outside the presence of an initiator, the polycarboxylic acid anhydride and the triglyceride being mixed with an initiator consisting essentially of 0.01-20% by mass of a polycarboxylic acid.

1. Polymeric material on the basis of renewable raw materials, comprising a reaction product produced by cross-linking from 10-90% by mass of a triglyceride having an epoxy or aziridine functional group, or a mixture of said triglycerides, and 5-90% by mass of a polycarboxylic acid anhydride, manufactured from cyclic polycarboxylic acids with at least two free carboxylic acid groups, with an initiator consisting essentially of 0.01-20% by mass of a polycarboxylic acid.

2. Polymeric material according to claim 1, wherein the epoxidized triglycerides are selected from the group consisting of soya oil, linseed oil, perilla oil, tung oil, oiticica oil, safflower oil, poppy oil, hemp oil, cottonseed oil, sunflower oil, rape oil, triglycerides from euphorbia plants such for example as euphorbia-iagascae oil, and highly-oleic triglycerides such for example as highly-oleic sunflower oil or euphorbia iathyris oil, groundnut oil, olive oil, olive seed oil, almond oil, kapok oil, hazelnut oil, apricot seed oil, beechnut oil, lupin oil, maize oil, sesame oil, grapeseed oil, lallemantia oil, castor oil, oils of sea creatures such as herring oil and sardine oil or menhaden oil, whale oil and triglycerides with a high proportion of saturated fatty acids which are subsequently converted to an unsaturated condition by dehydration, and mixtures thereof.

3. Polymeric material according to claim 1, wherein the epoxidized triglycerides additionally contain hydroxylized triglycerides such as castor oil.

4. Polymeric material according to claim 1, wherein the polycarboxylic acid anhydrides are selected from the group consisting of cyclohexane dicarboxylic acid anhydride, cyclohexene dicarboxylic acid anhydride, phthalic acid anhydride, trimellitic acid anhydride, hemimellitic acid anhydride, pyromellitic acid anhydride, 2,3-napthalic acid anhydride, 1,2 cyclopentane dicarboxylic acid anhydride, 1,2 cyclobutane dicarboxylic acid anhydride, quinolinic acid anhydride, norbornene dicarboxylic acid anhydride (NADICAN), and the methyl-substituted compounds MNA, pinic acid anhydride, norpinic acid anhydride, truxillic acid anhydride, perylene 1,2-dicarboxylic acid anhydride, caronic acid anhydride, narcamphane dicarboxylic acid anhydride, isatoic acid anhydride, camphoric acid anhydride, 1,8-naphthalic acid anhydride, diphenic acid anhydride, o-carboxyphenylbenzoic acid anhydride, 1,4,5,8-naphthalic intera carboxylic acid anhydride, and mixtures thereof.

5. Polymeric material according to claim 1, wherein a di- or tricarboxylic acid is used as a polycarboxylic acid.

6. Polymeric material according to claim 5, wherein the polycarboxylic acid is selected from the group consisting of citric acid derivates, polymerized tall oils, azelaic acid, gallic acid, di- or polymerized oleoresin acids, di- or polymerized anacardic acid, cashew nut shell liquid, polyuronic acids, polyalginic acids, mellitic acids, trimesic acids, aromatic polycarboxylic acids such for example as phthalic acid, trimellitic acid, hemimellitic acid, pyromellitic acid and their aromatically substituted derivates such for example as hydroxy or alkyl phthalic acid, unsaturated cyclic polycarboxylic acids such for example as norpinic acid, heterocyclic polycarboxylic acids such for example as loiponic acid or cincholoiponic acid, bi-cyclic polycarboxylic acids such for example as norbornene dicarboxylic acids, open-chained polycarboxylic acids such for example as malonic acid and its longer-chained homologues and its substituted compounds such for example as hydroxy- and keto- di- and polycarboxylic acids, pectinic acids, humic acids, polymeric cashew nut shell liquid with at least two free carboxylic acid groups in the molecule, and mixtures thereof.

7. Polymeric material according to claim 1, wherein it contains 2-98% by mass of a reaction product according to claim 1 and 98-2% by mass of a filler.

8. Polymeric material according to claim 1, wherein the filler is selected from the group consisting of organic fillers on the basis of cellulose-containing materials such as wood flour, sawdust or timer waste, rice husks, straw and flax fibers on the basis of proteins, particularly sheep wool and inorganic fillers on the basis of silicates and carbonates such as sand, quartz, corundum, silicon carbide and glass fibers, and mixtures thereof.

9. Polymeric material according to claim 1, wherein during production of the reaction product, 0.01-10% by mass of a catalyst are added.

10. Polymeric material according to claim 9, wherein the catalyst is selected from the group consisting of tertiary amines such as N, N′benzyldimenthyl aniline, imidazol and its derivates, alcohols, hydroxycarboxylic acids such as lactic acid or salicylic acid, and thio acids and organophosphorus compounds, particularly triphenylphosphite, trisnonylphenylphosphite, and bis-β-chloroethylphosphite, bi-cyclic amines such as 2,2,2, diazabicyclooctane, chinuclidine or diazabicycloundecenes, and mixtures thereof.

11. Polymeric material according to claim 1, wherein it includes a flame-retardant selected from the group consisting of aluminium hydroxide, halogen, antimony, bismuth, boron or phosphorus compounds, silicate compounds, and mixtures thereof.

12. Method of producing a polymeric material comprising mixing a triglyceride having an epoxy or aziridine functional group, a polycarboxylic acid anhydride, a polycarboxylic acid and optionally further additives such as fillers and/or catalyst and/or flame retardants; and hardening the mixture.

13. Method of producing the polymeric material according to claim 12, wherein the triglyceride, the polycarboxylic acid anhydride, the polycarboxylic acid and if necessary the catalyst are previously cross-linked to a viscosity of 0.2-20,000 CPS at 20° C.-200° C., in that then the filler and/or the flame retardant are added, and in that hardening is then carried out.

14. Method according to claim 12, wherein hardening is carried out at a temperature in the range of >20° C. to 200° C. and at a pressure of 1 bar to 100 bar for a period in the range of 10 seconds to 24 hours.

15. Polymeric material according to claim 6, wherein the aromatic polycarboxylic acids are selected from the group consisting of phthalic acid, trimellitic acid, hemimellitic acid, and pyromellitic acid.

16. Polymeric material according to claim 6, wherein the aromatically substituted derivatives of the aromatic polycarboxylic acids are selected from the group consisting of hydroxy-phthalic acid and alkyl-phthalic acid.

17. Polymeric material according to claim 6, wherein the unsaturated cyclic polycarboxylic acids are norpinic acid.

18. Polymeric material according to claim 6, wherein the heterocyclic polycarboxylic acids are selected from the group consisting of loiponic acid and cincholoiponic acid.

19. Polymeric material according to claim 6, wherein the bi-cyclic polycarboxylic acids are norbornene dicarboxylic acids, the open-chained polycarboxylic acids is malonic acid, and the longer-chained homologues and the substituted compounds of the open-chained polycarboxylic acids are selected from the group consisting of hydroxy-polycarboxylic acids, keto-polycarboxylic acids, and di-carboxylic acids.

20. Polymeric material according to claim 1, wherein the reaction product is produced by cross-linking 35% or more by mass of said triglyceride or mixture of said triglycerides.

21. Polymeric material according to claim 1, wherein the total of the triglyceride, or mixture of triglycerides, and said polycarboxylic acid anhydride in the reaction product is greater than 50% by mass.

22. A cross linked polymeric material based on renewable raw materials, comprising a reaction product produced by the reaction of a mixture consisting essentially of 10-90% by mass of a triglyceride having epoxy or aziridine groups or a mixture of said triglycerides, 5-90% by mass of a polycarboxylic acid anhydride manufactured from cyclic polycarboxylic acids with at least two free carboxylic acid groups, and 0.01-20% by mass of a polycarboxylic acid.

23. Polymeric material on the basis of renewable raw materials, comprising a reaction product produced by cross-linking from 10-90% by mass of a triglyceride having an epoxy or aziridine functional group, or a mixture of said triglycerides, and 5-90% by mass of a polycarboxylic acid anhydride, manufactured from cyclic polycarboxylic acids with at least two free carboxylic acid groups, the polycarboxylic acid anhydride and the triglyceride being essentially non-reactive with each other outside the presence of an initiator, the polycarboxylic acid anhydride and the triglyceride being mixed with an initiator consisting essentially of 0.01-20% by mass of a polycarboxylic acid.
